(19) United States
(12) Patent Application Publication
(10) Pub. No.: US 2025/0189203 A1
(43) Pub. Date: Jun. 12, 2025

(54) PORTABLE CRYOGENIC COOLER CONTAINER

(71) Applicant: Ember Technologies, Inc., Westlake Village, CA (US)

(72) Inventors: Clayton Alexander, Westlake Village, CA (US); Daren John Leith, Agoura Hills, CA (US); Fenton Lane Stith, Westlake Village, CA (US); Jacob William Emmert, Westchester, CA (US); Mikko Juhani Timperi, San Marcos, CA (US); Rahul Mulinti, Westlake Village, CA (US); Robert James Speck, Westlake Village, CA (US); Karim Tarazi, Westlake Village, CA (US); Rob Lawson-Shanks, Westlake Village, CA (US)

(21) Appl. No.: 18/845,366

(22) PCT Filed: Mar. 13, 2023
(86) PCT No.: PCT/US2023/064221

§ 371 Date: Sep. 9, 2024

Related U.S. Application Data
(60) Provisional application No. 63/269,426, filed on Mar. 16, 2022.

(51) Int. Cl. F25D 11/00; F17C 3/08; F17C 11/00

(52) U.S. Cl. CPC F25D 11/00; F17C 3/08; F17C 11/00; F17C 2201/058; F17C 2203/0391; F17C 2221/014; F17C 2223/0161; F17C 2250/034; F17C 2250/0439

(57) ABSTRACT

A portable cryogenic cooler container is provided, with a payload chamber for one or more temperature sensitive or perishable goods. A cooling unit is disposed in the payload chamber. The cooling unit includes a vessel filled with a cooling material (e.g., liquid nitrogen) and closed with a lid. One or more apertures of the cooling unit are operable to allow a chilled gas (e.g., gaseous nitrogen) to be vented without pressure build up in the cooler.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure is directed to a portable cooler, and more particularly to a portable cryogenic cooler container for shipping temperature sensitive goods (e.g., medicine, vaccines).

### Description of the Related Art

Portable coolers are used to store products in a cooled state. Cryogenic cooler containers are used to store products in a very cold state.

### SUMMARY

In accordance with one aspect of the disclosure a portable cryogenic cooler container is provided with a payload chamber for one or more temperature sensitive or perishable goods (e.g., medicine, vaccines). A cooling unit is disposed in the payload chamber. The cooling unit includes a vessel filled with a cooling material (e.g., liquid nitrogen) and closed with a lid. One or more apertures of the cooling unit are operable to allow a chilled gas (e.g., gaseous nitrogen) to be vented without pressure build up in the cooler.

In accordance with one aspect of the disclosure, a portable cryogenic cooler container is provided. The container comprises a vessel and a cryogenic Dewar vessel within the vessel. The cryogenic Dewar vessel includes an inner vessel having one or more openings in a wall that defines a payload chamber and an absorbent material disposed about the inner vessel, the Dewar vessel being vacuum insulated relative to the vessel. The container also comprises a lid operable to close the vessel. The lid has an upper lid portion and an elongate lid portion extending from the upper lid portion. The elongate lid portion is configured to extend into the vessel and adjacent the cryogenic Dewar vessel when the upper lid portion is adjacent the vessel. The elongate lid portion has a vent channel that communicates with an aperture in the upper lid portion. The container also comprises one or more temperature sensors configured to sense a temperature in the payload chamber, circuitry configured to communicate with the one or more temperature sensors and to wirelessly communicate with a remote electronic device, and a visual display configured to selectively display information in one or more screens. The container also comprises a button or touch screen manually actuatable by a user to cause circuitry electrically connected to the visual display to change the screen displayed on the visual display, wherein the cryogenic Dewar vessel is configured to receive liquid nitrogen therein to be absorbed by the absorbent material to cool the payload chamber.

In accordance with another aspect of the disclosure, a portable cryogenic cooler container is provided. The container comprises a vessel and a cryogenic Dewar vessel within the vessel. The cryogenic Dewar vessel includes an inner vessel having one or more openings in a wall that defines a payload chamber and an absorbent material disposed about the inner vessel. The container also comprises a lid operable to close the vessel. The lid has an upper lid portion and an elongate lid portion extending from the upper lid portion. The elongate lid portion is configured to extend into the vessel and adjacent the cryogenic Dewar vessel when the upper lid portion is adjacent the vessel. The elongate lid portion has a vent channel that communicates with an aperture in the upper lid portion. The container also comprises one or more temperature sensors configured to sense a temperature in the payload chamber, circuitry configured to communicate with the one or more temperature sensors and to wirelessly communicate with a remote electronic device, and a visual display configured to selectively display information in one or more screens. The container also comprises a button or touch screen manually actuatable by a user to cause circuitry electrically connected to the visual display to change the screen displayed on the visual display, wherein the cryogenic Dewar vessel is configured to receive liquid nitrogen therein to be absorbed by the absorbent material to cool the payload chamber.

### BRIEF DESCRIPTION OF THE DRAWINGS

FIG. 1 is a perspective view of a portable cryogenic cooler container.

FIG. 2 is a partial disassembled view of the portable cryogenic cooler container of FIG. 1.

FIG. 3 is a cross-sectional view of a portable cryogenic cooler container of FIG. 1.

FIG. 4 is a partial top view of a vessel of the portable cryogenic cooler container of FIG. 1.

FIG. 5 is a schematic block diagram showing communication between the cooler container and a remote electronic device.

FIGS. 6-9 show examples of different images that can be displayed on a visual display of the portable cryogenic cooler container.

### DETAILED DESCRIPTION

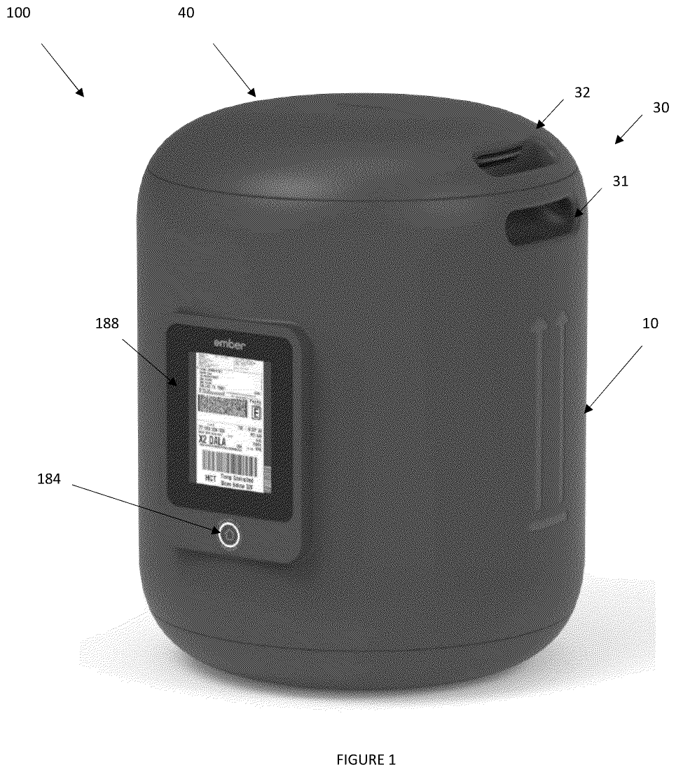

FIGS. 1-5 show a portable cryogenic cooler container 100 (the “cooler container”). The cooler container 100 can include a vessel 10 and a lid 40. The vessel 10 can optionally have indications (e.g., arrows) on the outer surface thereof to identify the top of the vessel to inform users how to orient the cooler container 100 (e.g., right side up). In one implementation, the lid 40 can be movably coupled to the vessel 10 (e.g., by a hinge between the lid 40 and the vessel 10). In another implementation, the lid 40 can be removably coupled to the vessel 10 (e.g., so that the lid 40 can be completely decoupled from the vessel 10). The cooler container 100 can include one or more (e.g., a pair of) handles 30 with a handle opening 31 in the vessel 10 that communicates with a handle opening 32 in the lid 40. The cooler container 100 also includes a visual display 188 (e.g., digital display, electronic display, electrophoretic display) that communicates with circuitry EM, as further discussed below. The visual display 188 and electronics, including circuitry EM, can be powered by one or more power storage elements PS (e.g., batteries). Optionally, the visual display 188 can display a shipping label (e.g. an electronic shipping label), as further discussed below. The cooler container 100 can optionally have a user interface 184 (e.g., depressible button, touch sensitive button, capacitive sensing button) that allows a user to automatically change the sender and recipient information (e.g., sender and recipient address information) on the shipping label by manually engaging the user interface 184, as further discussed below.

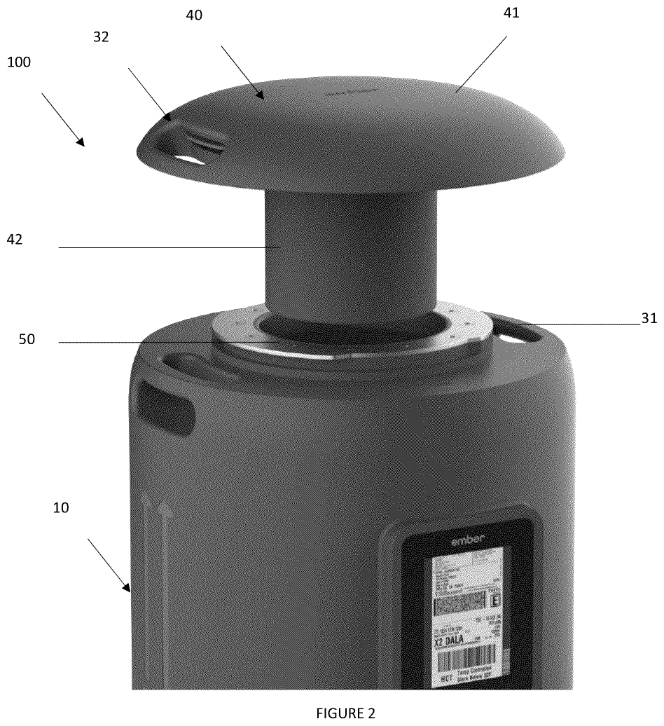

With reference to FIG. 2, the lid 40 includes an elongate portion 42 (e.g., tube shaped) that extends from an upper portion 41 of the lid 40, so that the elongate portion 42 extends into the vessel 10 when the upper portion 41 is adjacent a top end of the vessel 10. The elongate portion 42 can be filled with a cork material. The cooler container 100 includes a lock mechanism 50 (e.g., bayonet lock mechanism, key/slot lock mechanism) for locking the lid 40 onto the vessel 10 (e.g., to inhibit or prevent inadvertent decoupling of the lid 40 and the vessel 10).

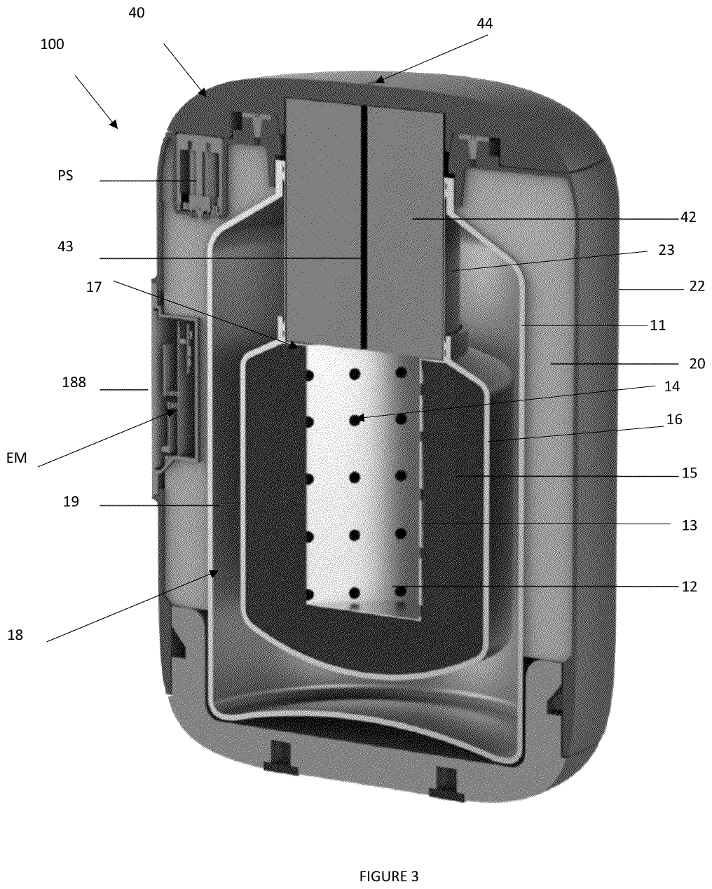

With reference to FIG. 3, the vessel 10 can in one implementation be a multi-walled vessel 10 with a payload chamber 12 defined by an inner vessel 13 with one or more openings 14, a second vessel 18 (e.g., cryogenic Dewar) disposed about the inner vessel 13 and having an inner wall 16 and an outer wall 19 spaced from the inner wall 16. The inner vessel 13 is connected to the inner wall 16 by a flange 17, an absorbent material 15 is disposed between the inner wall 16 and the inner vessel 13. An outer wall 22 is disposed about and spaced from the second vessel 18 (e.g., cryogenic Dewar), with insulation material 20 disposed between the outer wall 22 and the outer wall 19 of the second vessel 18 (e.g., cryogenic Dewar). In one example, the insulation material 20 is EPS foam (e.g., expanded polystyrene foam). However, the insulation material 20 can be other suitable insulative materials. The outer wall 22 can be made of an impact resistant material (e.g., plastic). A peripheral wall 23 can extend between the upper end of the inner wall 16 and the upper end of the outer wall 19 (e.g., to provide a sealed container, such as a vacuum insulated space between the inner wall 16 and outer wall 19). The elongate portion 42 of the lid 40 can extend into the second vessel 18 (e.g., cryogenic Dewar), such as within the peripheral wall 23, and contact the flange 17 (e.g., to seal the payload chamber 12). The elongate portion 42 can have a vent channel 43 that extends through the elongate portion 42 (e.g., extends through the cork material in the elongate portion 42 to an opening 44 (e.g., one or more openings) on the upper portion 41 of the lid 40.

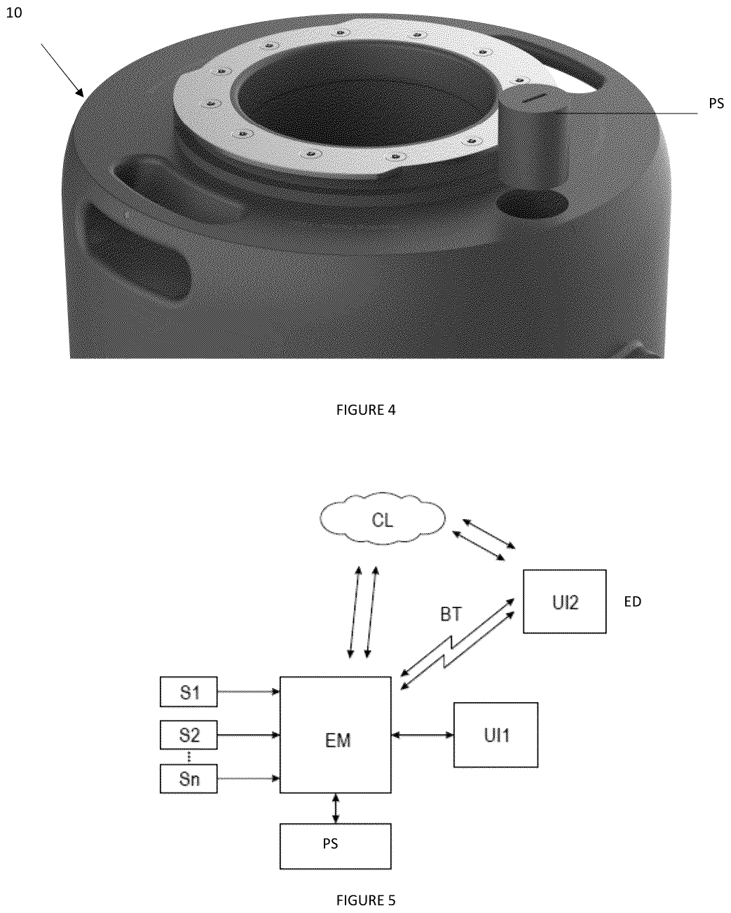

With reference to FIG. 4, the one or more power storage elements PS can be removably disposed in the vessel 10. The one or more power storage elements PS can be removed to be recharged or replaced.

In operation, liquid nitrogen is poured into the double walled insulated Dewar vessel (e.g., second vessel 18, such as via the chamber 12) to be absorbed into the absorbent material 15 lined against the inner wall 16 of the second vessel 18. The amount absorbed is based on the required transit time for the cooler container 100 along with the ambient temperature profile (e.g., during transit). After the absorbent material 15 is saturated, excess liquid nitrogen is emptied out of the vessel 10 (e.g., from the chamber 12), leaving the payload chamber 12 “dry”. The payload (e.g., vaccines, medicine) can be introduced into the payload chamber 12 and the vessel 10 sealed with the lid 40 (e.g., the payload chamber 12 sealed with the elongate member 42). The vent 43 in the elongate member 42 allows for gaseous nitrogen to escape without pressure build up.

FIG. 5 shows a block diagram of a control system for (e.g., incorporated into) the devices described herein (e.g., the cooler container 100). In the illustrated embodiment, circuitry EM (e.g., control circuitry, microcontroller unit MCU, computer processor(s), etc.) can receive sensed information from one or more sensors S1-Sn (e.g., level sensors, volume sensors, temperature sensors, pressure sensors, orientation sensors such as gyroscopes, accelerometers, battery charge sensors, biometric sensors, load/weight sensors, Global Positioning System or GPS sensors, radiofrequency identification or RFID reader, etc.).

In one implementation, at least one temperature sensor Sn (e.g., Sn1, Sn2 and/or Sn3) is in the vessel 10 or lid 40 and exposed to the payload chamber 12 to sense a temperature in the payload chamber 12. In another implementation, additionally or alternatively, at least one temperature sensor Sn, Ta is on the vessel 10 or lid 40 and exposed to the outside of the cooler container 100 to measure ambient temperature. In one implementation, the RFID reader in the vessel 10 or lid 40 can read RFID tags of components (e.g., medication, vials, vaccine doses) placed in the payload chamber 12. The RFID reader can optionally log when the payload contents are inserted into the payload chamber 12, and additionally or alternatively the RFID reader can optionally log when each of the one or more of the payload contents is removed from the payload chamber 12 to track their position relative to the vessel 10 and communicate this information to the circuitry EM (e.g., to a memory of the circuitry EM), which can optionally communicate the information wirelessly to a remote electronic device (e.g., computer server, tablet computer, smartphone) or the cloud CL.

In one implementation, one or more of the sensors S1-Sn can include a pressure sensor. The pressure sensor can optionally sense ambient pressure, which can be indicative of an altitude of the cooler container 100. Optionally, the pressure sensor communicates sensed pressure information to the circuitry EM, which can optionally log or record the data from the pressure sensor and/or can operate one or more components of the cooling system 200, as discussed above based at least in part on the sensed pressure information from the pressure sensor (e.g., which can be indicative of temperature in the payload chamber 12 to maintain the payload chamber 12 at a desired temperature or temperature range). Such pressure sensor(s) can advantageously allow the cooling system 200 to operate such that the payload chamber 12 is at a desired temperature or temperature range while the cooler container 100 in in transit (e.g., in high altitude locations), such as on an airplane or truck.

In one implementation, one or more of the sensors S1-Sn can include an accelerometer. The accelerometer can optionally sense motion (e.g., sudden movement) of the cooler container 100. Optionally, the accelerometer communicates with the circuitry EM, which can optionally log or record the data from the accelerometer. Such accelerometer(s) can advantageously sense, for example, when the cooler container 100 has been dropped (e.g., from an unsafe height) or experienced a shock, for example while in transit, such as on an airplane or truck. In one implementation, the accelerometer can also provide the circuitry EM with sensed orientation information of the cooler container 100, which can optionally communicate the information wirelessly to a remote electronic device (e.g., computer server, tablet computer, smartphone) or the cloud CL. In another implementation, a separate orientation sensor (e.g., a gyroscope), can sense an orientation of the cooler container 100 and communicate the sensed orientation information to the circuitry EM, which can optionally log or record the data from the orientation sensor.

The circuitry EM can be housed in or on the container vessel 10 or lid 40. Optionally, the circuitry EM can include a wireless transmitter, receiver and/or transceiver to communicate with (e.g., transmit information, such as sensed temperature and/or position data, to and receive information, such as user instructions, from one or more of: a) a user interface UI1 on the unit (e.g., visual display 188, on the body of the container vessel 10), b) an electronic device ED (e.g., a mobile electronic device such as a mobile phone, PDA, tablet computer, laptop computer, electronic watch, a desktop computer, remote server, cloud server), c) via the cloud CL, or d) via a wireless communication system such as WiFi, broadband network and/or Bluetooth BT. For example, the circuitry EM can have a cell radio antenna or cell radio (e.g., LTE cell radio, LTE-M cell radio) via which it can communicate information (e.g., GPS location, sensed temperature in the payload chamber 12, ambient temperature, etc.) wirelessly (e.g., to the cloud CL, to a remote electronic device, such as a smartphone, etc.). A user can then track a location of the cooler container 100 (e.g., via a website or app on a smartphone). Additionally or alternatively, the circuitry EM can report data sensed by one or more of the sensors S1-Sn (e.g., sensed ambient temperature, sensed temperature in the payload chamber 12, sensed pressure, sensed humidity outside the payload chamber 12, sensed humidity inside the payload chamber 12), for example wirelessly, to a remote electronic device or the cloud CL (e.g., transmit a report to a pharmacy or medical institution with a log temperature, pressure and/or humidity information of the contents of the cooler container 100 during transit to said pharmacy or medical institution). The electronic device ED can have a user interface UI2, that can display information associated with the operation of the cooler container 100, and that can receive information (e.g., instructions) from a user and communicate said information to the cooler container 100.

In operation, the cooler container 100 can operate to maintain the payload chamber 12 of the cooler container 100 at a preselected temperature and/or within a predetermined temperature range.

Optionally, the circuitry EM of the cooler container 100 can communicate (e.g., wirelessly) information to a remote location (e.g., cloud based data storage system, remote computer, remote server, mobile electronic device such as a smartphone or tablet computer or laptop or desktop computer) and/or to the individual carrying the container (e.g., via their mobile phone, via a visual interface on the container, etc.), such as a temperature history of the payload chamber 12 to provide a record that can be used (e.g., to evaluate the efficacy of the medication in the container, to evaluate if contents in the payload chamber 12 have been exposed to an undesired temperature making them unusable, etc.) and/or alerts on the status of the payload chamber 12 and/or contents in the payload chamber 12.

In one implementation, the one or more sensors S1-Sn of the cooler container 100 can include one more Global Positioning System (GPS) sensors for tracking the location of the cooler container 100. The location information can be communicated, as discussed above, by a transmitter (e.g., cell radio antenna or cell radio, such as LTE cell radio) and/or transceiver associated with the circuitry EM to a remote location (e.g., a mobile electronic device, a cloud-based data storage system, etc.). In one implementations, the GPS location is communicated (e.g., automatically, not in response to a query or request) by the circuitry EM at regular intervals (e.g., every minute, every 5 minutes, every 10 minutes, every 15 minutes, etc.). In another implementation, the GPS location is communicated by the circuitry EM upon receipt of a request or query, such as from the user (e.g., via an app or website via which the user can track the location of the cooler container 100).

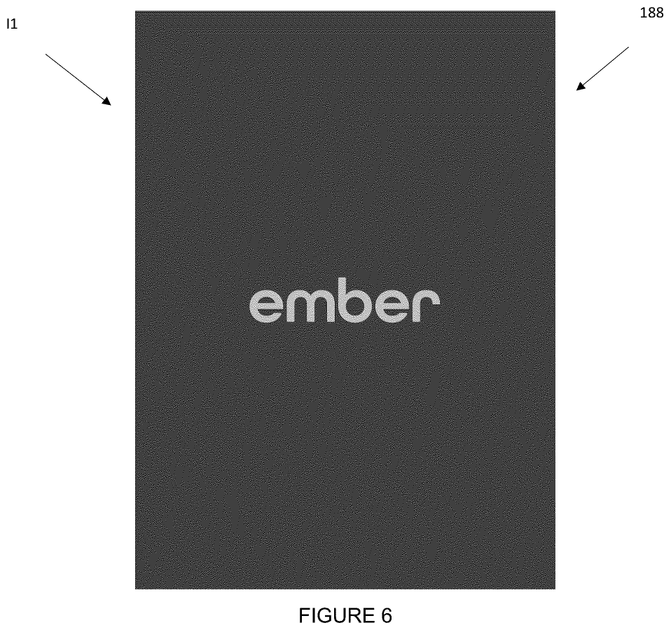

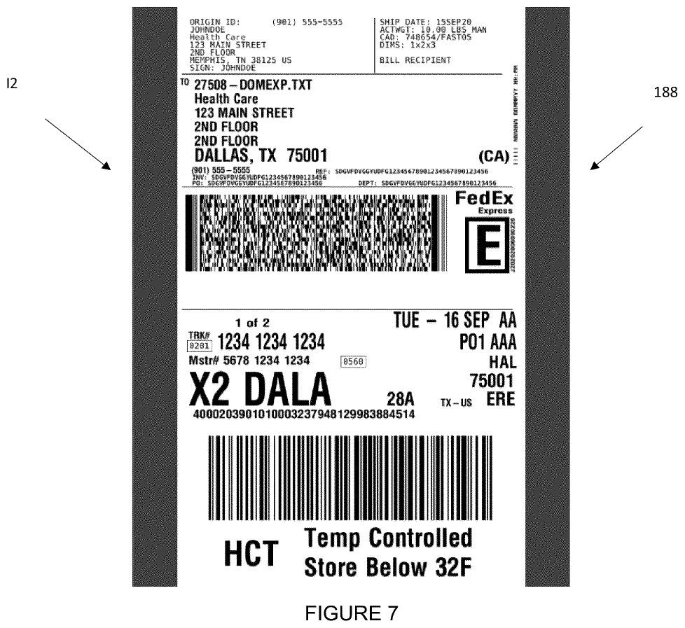

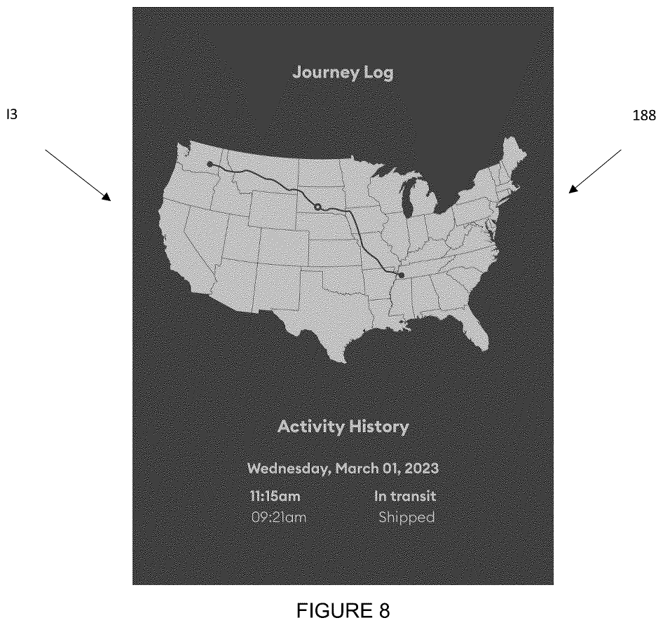

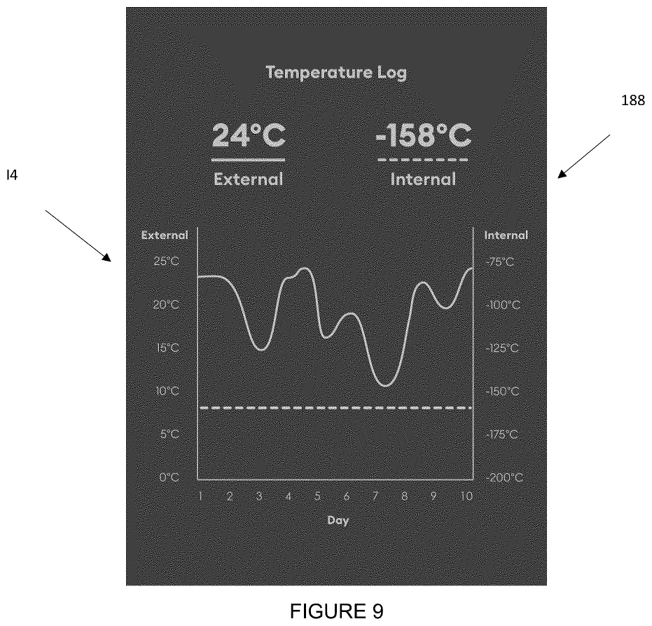

As discussed above, the cooler container 100 can have a visual display 188 (e.g., electrophoretic display). Optionally, the visual display 188 can display a shipping label (e.g. an electronic shipping label). The cooler container 100 can optionally have a user interface 184 (e.g., depressible button, touch sensitive button, capacitive sensing button) that allows a user to automatically change the sender and recipient information (e.g., sender and recipient address information) on the shipping label by, for example, manually engaging the user interface. The visual display 188 can display one or more screens or images I1-I4 (see FIGS. 6-9). In one implementation, the visual display 188 can cycle through the various screens or images I1-I4 with the actuation of the user interface 184 (e.g., when the user interface 184 is a depressible button or a capacitive sensing button, the screen shown on the visual display 188 can change every time the button is pressed or touched). One of the screens or images can be a home screen I1, for example as shown in FIG. 6. Another of the screens or images I2 can be a shipping label, as shown in FIG. 7. Another of the screens or images I3 can show a geographical trajectory (e.g., journey log) of the container 100 during a shipping trip, as shown in FIG. 8. Another of the screens or images I4 can show a temperature history of the container 100 during a period of time (e.g., during a shipping trajectory), as shown in FIG. 9. The temperature history can be displayed as a graph showing a temperature in the payload chamber 12 during said period of time. Additionally or alternatively, the temperature history can be displayed as a graph showing ambient temperature history experienced by the container 100 during said period of time.

The cooler container 100 includes a visual display 188 (e.g., on a side surface, on a top surface, of the cooler container 100). The visual display 188 can optionally be an electronic ink or E-ink display (e.g., electrophoretic ink display). In another implementation, the visual display 188 can be a digital display (e.g., liquid crystal display or LCD, light emitting diode or LED, etc.). Optionally, the visual display 188 can display a label (e.g., a shipping label with one or more of an address of sender, an address of recipient, a Maxi Code machine readable symbol, a QR code, a routing code, a barcode, and a tracking number), but can optionally additionally or alternatively display other information (e.g., temperature history information, information on the contents of the cooler container 100). The user interface 184 can optionally be a button (e.g., a “return home” or “return to sender” button). In one implementation, the user interface 184 is a depressible button. In another implementation, the user interface 184 is a capacitive sensor (e.g., touch sensitive sensor, touch sensitive switch). In another implementation, the user interface 184 is a sliding switch (e.g., sliding lever). In another implementation, the user interface 184 is a rotatable dial. In still another implementation, the user interface 184 can be a touch screen portion (e.g., separate from or incorporated as part of the visual display 188). Advantageously, actuation of the user interface 184 can automatically alter the information shown on the visual display 188, such as the form of a shipping label shown on the visual display 188 (e.g., electrophoretic or E-ink display). For example, actuation of the user interface 184, can automatically switch the text associated with the sender and recipient (e.g., sender mailing address and recipient mailing address), allowing the cooler container 100 to be shipped back to the sender once the recipient is done with it. Additionally or alternatively, actuation of the user interface 184 simultaneously and automatically causes a signal to be sent by circuitry EM in the cooler container 100, as discussed above, to a shipping carrier (e.g., UPS, FedEx, DHL) informing the shipping carrier that a shipping label (e.g., new shipping label) has been assigned to the cooler container 100 and that the cooler is ready for pick-up and shipping.

Advantageously, the cooler container 100 can be reused multiple times (e.g., 500 times, 1000 times, 1500 times, 20000 times), providing a sustainable cooler container for the delivery of perishable material (e.g., medicine, vaccines). Additionally, the cooler container 100 is easy to use and streamlines the shipping process. For example, the user interface 184 (e.g., button) makes it easy to return the container without having to print a new shipping label and without having to separately contact the shipping carrier for pickup, thereby improving the productivity of personnel handling the packages. The cooler container 100 can be stacked, for example in columns of six cooler containers 100, allowing a user to stack and unstack them without the need for a ladder. Advantageously, the cooler container can maintain the payload chamber 12 (e.g., and payload, such as medicine or vaccines at a temperature of less than −150 degrees Celsius for at least 10 days when in a vertical orientation). Additionally, the cooler container 100 can advantageously allow the charging of the absorbent material 15 in less than 3 hours. The cooler container 100 can be approximately 30 inches tall and about 20 inches in diameter. Advantageously, in one implementation, the user can press on the user interface 184 and the visual display 188 can provide an indication (e.g., thumbs up, graph of temperature vs. time during transit of the shipper—such as between when lid 40 is first coupled to vessel 10 and when it is decoupled from vessel 10) showing that temperature in payload chamber 12 has been below the required temperature (e.g., below −150 degrees Celsius) for the entire transit of the cooler container 100. Alternatively, the visual display 188 can show (when the user presses on the user interface 184) whether the temperature in the payload chamber 12 has at any time during transit been outside the required temperature or temperature range.

### Additional Embodiments

In embodiments of the present invention, a portable cryogenic cooler container may be in accordance with any of the following clauses:

Clause 1: A portable cryogenic cooler container, comprising:
a vessel;
a cryogenic Dewar vessel within the vessel and including an inner vessel having one or more openings in a wall that defines a payload chamber and an absorbent material disposed about the inner vessel;
a lid operable to close the vessel and having an upper lid portion and an elongate lid portion extending from the upper lid portion, the elongate lid portion configured to extend into the vessel and adjacent the cryogenic Dewar vessel when the upper lid portion is adjacent the vessel, the elongate lid portion having a vent channel that communicates with an aperture in the upper lid portion;
one or more temperature sensors configured to sense a temperature in the payload chamber;
circuitry configured to communicate with the one or more temperature sensors and to wirelessly communicate with a remote electronic device;
a visual display configured to selectively display information in one or more screens; and
a button or touch screen manually actuatable by a user to cause circuitry electrically connected to the visual display to change the screen displayed on the visual display,
wherein the cryogenic Dewar vessel is configured to receive liquid nitrogen therein to be absorbed by the absorbent material to cool the payload chamber.

Clause 2: The cooler container of Clause 1, wherein the one or more screens includes one or more of a home screen, a screen displaying a shipping label, a screen displaying a geographical trajectory of the cooler container, and a screen displaying a temperature history of the cooler container over a period of time.

Clause 3: The cooler container of Clause 2, wherein the screen displaying the temperature history of the cooler container over a period of time includes one of both of a temperature history of a sensed temperature in the payload chamber and a temperature history of an ambient temperature experienced by the cooler container over the period of time.

Clause 4: The cooler container of any preceding clause, wherein the visual display is operable to cycle through the one or more screens via actuation of the button or touch screen.

Clause 5: The cooler container of any preceding clause, wherein the button or touch screen is manually actuatable by a user to cause the circuitry electrically connected to the visual display to one or both of a) automatically switch a sender and a recipient information on a shipping label displayed on the visual display to facilitate return of the portable cryogenic cooler container to a sender and b) automatically wirelessly send a signal to a shipping carrier to alert the shipping carrier that the portable cryogenic cooler container is ready for pickup.

Clause 6: The cooler container of any preceding clause, further comprising one or more power storage elements removably disposed in the vessel.

Clause 7: The cooler container of any preceding clause, wherein the circuitry comprises a cell radio antenna.

Clause 8: The cooler container of any preceding clause, further one or more handles with a handle opening in the vessel that communicates with a handle opening in the lid.

Clause 9: The cooler container of any preceding clause, further comprising insulation material disposed between the vessel and the cryogenic Dewar vessel.

Clause 10: The cooler container of any preceding clause, wherein the vessel comprises an impact resistant material.

Clause 11: The cooler container of any preceding clause, wherein the visual display is an electrophoretic display.

Clause 12: The cooler container of any preceding clause, further comprising one or more temperature sensors configured to sense ambient temperature and to communicate with the circuitry.

Clause 13: The cooler container of any preceding clause wherein the cryogenic Dewar vessel is insulated relative to the vessel.

Clause 14: The cooler container of Clause 14, wherein the cryogenic Dewar vessel is vacuum insulated relative to the vessel.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

1. A portable cryogenic cooler container, comprising:
a vessel;
a cryogenic Dewar vessel within the vessel and including an inner vessel having one or more openings in a wall that defines a payload chamber and an absorbent material disposed about the inner vessel, the Dewar vessel being vacuum insulated relative to the vessel;
a lid operable to close the vessel and having an upper lid portion and an elongate lid portion extending from the upper lid portion, the elongate lid portion configured to extend into the vessel and adjacent the cryogenic Dewar vessel when the upper lid portion is adjacent the vessel, the elongate lid portion having a vent channel that communicates with an aperture in the upper lid portion;
one or more temperature sensors configured to sense a temperature in the payload chamber;
circuitry configured to communicate with the one or more temperature sensors and to wirelessly communicate with a remote electronic device;
a visual display configured to selectively display information in one or more screens; and
a button or touch screen manually actuatable by a user to cause circuitry electrically connected to the visual display to change the screen displayed on the visual display,
wherein the cryogenic Dewar vessel is configured to receive liquid nitrogen therein to be absorbed by the absorbent material to cool the payload chamber.

2. The cooler container of claim 1, wherein the one or more screens includes one or more of a home screen, a screen displaying a shipping label, a screen displaying a geographical trajectory of the cooler container, and a screen displaying a temperature history of the cooler container over a period of time.

3. The cooler container of claim 2, wherein the screen displaying the temperature history of the cooler container over a period of time includes one of both of a temperature history of a sensed temperature in the payload chamber and a temperature history of an ambient temperature experienced by the cooler container over the period of time.

4. The cooler container of claim 1, wherein the visual display is operable to cycle through the one or more screens via actuation of the button or touch screen.

5. The cooler container of claim 1, wherein the button or touch screen is manually actuatable by a user to cause the circuitry electrically connected to the visual display to one or both of a) automatically switch a sender and a recipient information on a shipping label displayed on the visual display to facilitate return of the portable cryogenic cooler container to a sender and b) automatically wirelessly send a signal to a shipping carrier to alert the shipping carrier that the portable cryogenic cooler container is ready for pickup.

6. (canceled)

7. The cooler container of claim 1, wherein the circuitry comprises a cell radio antenna.

8. The cooler container of claim 1, further one or more handles with a handle opening in the vessel that communicates with a handle opening in the lid.

9. The cooler container of claim 1, further comprising insulation material disposed between the vessel and the cryogenic Dewar vessel.

10. (canceled)

11. (canceled)

12. The cooler container of claim 1, further comprising one or more temperature sensors configured to sense ambient temperature and to communicate with the circuitry.

13. A portable cryogenic cooler container, comprising:
a vessel;
a cryogenic Dewar vessel within the vessel and including an inner vessel having one or more openings in a wall that defines a payload chamber and an absorbent material disposed about the inner vessel;
a lid operable to close the vessel and having an upper lid portion and an elongate lid portion extending from the upper lid portion, the elongate lid portion configured to extend into the vessel and adjacent the cryogenic Dewar vessel when the upper lid portion is adjacent the vessel, the elongate lid portion having a vent channel that communicates with an aperture in the upper lid portion;
one or more temperature sensors configured to sense a temperature in the payload chamber;
circuitry configured to communicate with the one or more temperature sensors and to wirelessly communicate with a remote electronic device;
a visual display configured to selectively display information in one or more screens; and
a button or touch screen manually actuatable by a user to cause circuitry electrically connected to the visual display to change the screen displayed on the visual display,
wherein the cryogenic Dewar vessel is configured to receive liquid nitrogen therein to be absorbed by the absorbent material to cool the payload chamber.

14. The cooler container of claim 13, wherein the one or more screens includes one or more of a home screen, a screen displaying a shipping label, a screen displaying a geographical trajectory of the cooler container, and a screen displaying a temperature history of the cooler container over a period of time.

15. The cooler container of claim 14, wherein the screen displaying the temperature history of the cooler container over a period of time includes one of both of a temperature history of a sensed temperature in the payload chamber and a temperature history of an ambient temperature experienced by the cooler container over the period of time.

16. The cooler container of claim 13, wherein the visual display is operable to cycle through the one or more screens via actuation of the button or touch screen.

17. The cooler container of claim 13, wherein the button or touch screen is manually actuatable by a user to cause the circuitry electrically connected to the visual display to one or both of a) automatically switch a sender and a recipient information on a shipping label displayed on the visual display to facilitate return of the portable cryogenic cooler container to a sender and b) automatically wirelessly send a signal to a shipping carrier to alert the shipping carrier that the portable cryogenic cooler container is ready for pickup.

18. (canceled)

19. The cooler container of claim 13, wherein the circuitry comprises a cell radio antenna.

20. The cooler container of claim 13, further one or more handles with a handle opening in the vessel that communicates with a handle opening in the lid.

21. The cooler container of claim 13, further comprising insulation material disposed between the vessel and the cryogenic Dewar vessel.

22. (canceled)

23. (canceled)

24. The cooler container of claim 13, further comprising one or more temperature sensors configured to sense ambient temperature and to communicate with the circuitry.

25. The cooler container of claim 13, wherein the cryogenic Dewar vessel is insulated relative to the vessel.

26. The cooler container of claim 25, wherein the cryogenic Dewar vessel is vacuum insulated relative to the vessel.
